(19) United States
(12) Patent Application Publication
(10) Pub. No.: US 2004/0034698 A1
(43) Pub. Date: Feb. 19, 2004

(54) Instant fix for embedded device support using remote commands

(76) Inventors: Loay Mahmoud Abu-Husein, Boise, ID (US); Grady G. Cooper, Boise, ID (US); Joseph E. Halpern III, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/219,149

(22) Filed: Aug. 15, 2002

(51) Int. Cl. G06F 15/173

(52) U.S. Cl. 709/223

(57) ABSTRACT

The present invention relates to a system and method for fixing commonly occurring errors or problems with an electronic device. More particularly, the present invention relates to the use of an e-service associated with a printing device for retrieving lists of frequently encountered problems and fixes to those problems from a database, or web site, and implementing fixes to selected problems on the printing device.

### FIELD OF THE INVENTION

The present invention relates to a system and method for fixing commonly occurring errors or problems with an electronic device. More particularly, the present invention relates to systems and methods for using an electronic device to retrieve a solution and fix a frequently encountered problem associated with the electronic device from a remote location.

### BACKGROUND OF THE INVENTION

The use of computers and computing devices for both personal and business use is on the rise. As the use of computing devices increase, so too does the use of accessories typically associated with such computing devices. For instance, printing devices such as printers, copiers, multifunction devices, and the like, are frequently associated with computing devices for producing hardcopies of documents or other media created using the computing device. In addition, advances in technology provide a steady stream of accessories that may be incorporated with computing devices or a network of computing devices. In many instances, the addition of such accessories requires new software and hardware to support and properly operate the accessories.

Frequently, a computing device accessory, such as a printing device, may include a plethora of options that may be configured with the printing device. Default options and operational parameters are typically included with a printing device so that it may be added to a computer network or connected to an individual computing device, and used without any problems. However, if changes in the options and default settings of a printing device are desired, it may be difficult to initiate a change unless a user is thoroughly familiar with the operational workings of the printing device. This is rarely the case, especially in those instances where a printing device is incorporated with a home computing system.

Many companies have established customer care centers or service centers to help customers and users of a company's products solve problems that may arise on a daily basis. Access to a customer service center may be provided with the purchase of a device or may be provided as a purchasable option with the device. A customer having a problem with a device may call the customer service center and speak to a representative in an attempt to solve the problem encountered. Typically, customer service center calls may take anywhere from twenty to forty minutes in order to resolve a problem. In addition, the solution of some problems may lead to additional problems because a fix is not properly implemented or an inadvertent change is made in the process of fixing a first problem. This may lead to the need for additional customer service center calls and additional downtime for the device being used. Problems associated with fixes provided by a customer service center arise quite frequently due to miscommunication and the lack of understanding of most device users. Such problems are especially prevalent where device programming is required to initiate a fix and the user has little or no understanding of how to program a device.

An example of a typical call to a customer service center involves a question regarding the process required to set a different default paper size for a printing device. A user, desiring to change the default paper size for a printing device, calls a customer service center associated with the device. After being connected to a customer service representative the user and customer service center representative attempt to correct the problem. Establishing a connection to the customer service representative may take some time depending upon the number of users attempting to use the customer service center. The customer service representative provides the user with the proper instructions to change the printing device default paper size. The user walks through these steps while on the phone or after disconnecting with the customer service representative. However, if the suggested changes are unsuccessful, a second call to the customer service center may be avoided by remaining in direct contact with the customer service center.

In some cases, a customer service center may have to suggest changes to software or computer configurations in order to fix a problem with a computing device or accessory. In such instances, the likelihood of creating additional errors by fixing the existing error increases because more sophisticated changes are being made. It is therefore desirable for customer service centers to avoid suggesting software changes, or other computer configuration changes, that may potentially create additional problems.

In addition to live customer service centers providing individualized help, there have been some proposed e-mail services wherein a user e-mails a problem to a customer service center. A solution to the problem is then e-mailed back to a customer after being handled by a customer service representative. This solution, however, often creates additional problems because a user may have already attempted a particular solution recommended by the return e-mail, which would require the sending of an additional e-mail and downtime while waiting for a response. Also, the downtime of a device during the period in which a user is waiting for an e-mail response may be costly.

The current customer service operations are disadvantageous in that they are costly for both the customers and the companies trying to support their products. In addition, present solutions often result in additional problems due to human error and miscommunication. Therefore, it would be desirable to provide an automated customer service for providing solutions to common problems associated with computing devices and their accessories.

### BRIEF SUMMARY OF THE INVENTION

The present invention relates to a system and method for fixing commonly occurring errors or problems with an electronic device. More particularly, the present invention relates to systems and methods for using an electronic device to retrieve a solution and fix a frequently encountered problem associated with the electronic device from a remote location.

The various embodiments of the present invention provide an alternative solution for fixing frequently encountered problems associated with electronic devices such as printing devices. Traditionally, attempted solutions to problems faced by users of printing devices were obtained through conversation with a customer service representative and attempted programming alterations. Using the various embodiments of the present invention, the customer service representative is bypassed and the electronic device, such as a printing device, may be used to automatically execute a fix for a problem selected by a user.

In one embodiment of the present invention an e-service may be installed on a printing device for fixing frequently encountered problems. The e-service may communicate with a remote web site for retrieving lists of frequently encountered problems and fixes associated with each of the listed problems. A user may select the desired problem to be fixed and the e-service retrieves and executes a set of fix commands for fixing the selected problem. Thus, a user may fix a problem associated with a printing device using the e-service operating on the printing device. This provides a user friendly, secure, and reliable system and method for fixing problems associated with a printing device.

A web site associated with an e-service, and accessed by the e-service residing on a printing device, may be maintained by a customer care center. Lists of known problems associated with various electronic devices may be stored in databases that are accessible to the web site. In addition, solutions to the various problems may also be stored in the databases. When an e-service accesses a web site maintained by the customer care center, the web site may access the databases to retrieve lists of frequently encountered problems associated with the particular printing device requesting a fix. The problems and associated fix codes may be passed to a requesting e-service to fix a problem. Because the e-service requests the fix, firewall traversal problems are also avoided.

In addition, the customer care center may add known problems and solutions to the databases in order to maintain up-to-date solutions to frequently encountered problems. As additional, or more efficient, fixes to frequently encountered problems are developed, the databases may be updated with the new fixes so that users may always access the most recent fixes for frequently encountered problems.

In another embodiment of the present invention, a user may request that the e-service search a database hosted by a customer care center for a particular problem and the fix to that problem. The e-service may include a function or set of programming for creating a search form that a user may use to input search parameters in an effort to better define, and refine, searches for fixes. The e-service may use the inputted search parameters to retrieve one or more problems and fixes related to the search parameters from a database.

The various embodiments of the present invention provide an efficient and virtually automatic system and methods for fixing problems associated with printing devices. Automating the problem selection process and bypassing communications with customer care representatives may accomplish fixes for problems quickly, reliably and cheaply. Furthermore, fixes to the problems are also handled automatically, eliminating problems that may arise due to human error or miscommunication of fix procedures.

### BRIEF DESCRIPTION OF THE SEVERAL VIEWS OF THE DRAWINGS

While the specification concludes with claims particularly pointing out and distinctly claiming that which is regarded as the present invention, the present invention can be more readily ascertained from the following description of the invention when read in conjunction with the accompanying drawings in which:

FIG. 1 illustrates a block diagram of a system that may be used to carry out the various embodiments of the present invention;

FIG. 2 illustrates a flow diagram of the logic that may be used to carry out the various embodiments of the present invention; and

FIG. 3 illustrates a block diagram of a system that may be used to carry out the various embodiments of the present invention from a remote location.

### DETAILED DESCRIPTION OF THE INVENTION

The various embodiments of the present invention involve a system and methods for automatically correcting frequently encountered problems associated with electronic devices having embedded web client/server services, such as printing devices, personal digital assistant devices, cellular phones, digital imaging devices, and the like. A communication link may be established between an electronic device and a customer care center web site for transmitting information from the customer care center web site to the electronic device for fixing problems associated with the electronic device. Use of the present invention provides instant fixes to common problems without tedious and expensive communications with a customer care center representative.

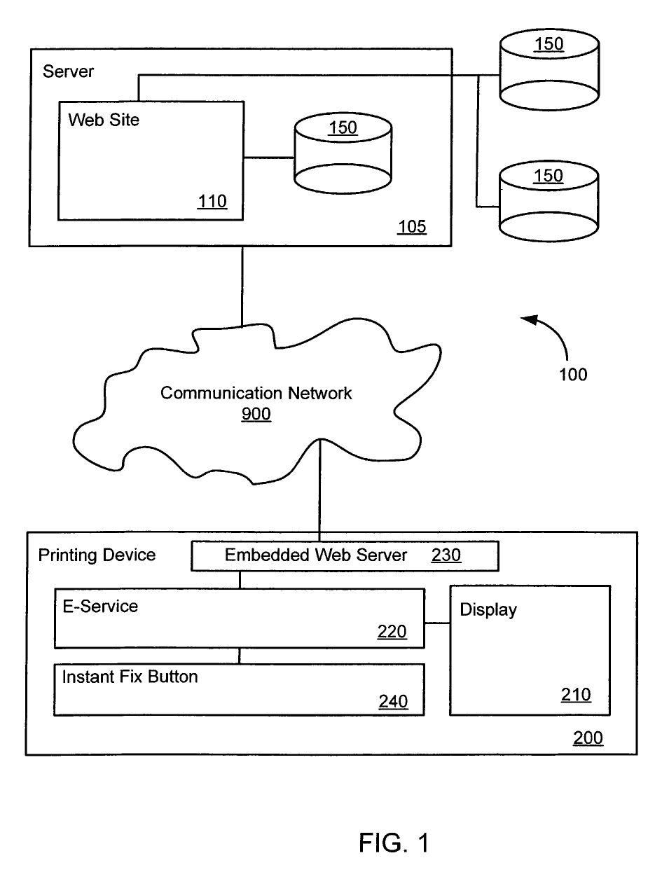

A system 100 that may be used to carry out the various embodiments of the present invention is illustrated as a block diagram in FIG. 1. A customer care center web site 110 may be stored on, or operate on, a server 105 or other computing device. The web site 110 may be linked to a communication network 900 such as a computing network, an intranet, or the Internet. One or more databases 150 may be accessible to the web site 110 for providing information about frequently encountered problems for certain electronic devices. The web site 110 may be accessible to an electronic device, such as a printing device 200, using the communication network 900.

A server 105 may store the necessary data for hosting web site 110 on a storage device associated with server 105 or in a memory associated with server 105 as known. Server 105 may be any computer or computing device capable of hosting information and data for communication with a web browser or other device, including a server system or networked computer system.

Databases 150 may also be stored on a storage device or in a memory associated with server 105. Alternatively, databases 150 may be stored on a storage device that is remote to the server 105, such as a storage device associated with another computer (not shown). A database 150 may contain information and data about frequently encountered problems associated with one or more electronic devices. A database 150 may also include information that may be used to correct a frequently encountered problem stored in the database. For instance, a frequently encountered problem associated with a certain type of printing device 200 may comprise a problem associated with the changing of the default paper size for the printing device 200. A database 150 may store information describing the problem with changing the default paper size along with one or more solutions that may operate on printing device 200 to correct the problem. Thus, database 150 may provide both a description of a problem and one or more solutions to the problem. Multiple databases 150 may be associated with a server 105 or web site 110 for providing descriptions of problems and solutions for those problems for numerous electronic devices.

An electronic device may utilize the various embodiments of the present invention to automatically fix problems associated with the electronic device. For the purposes of describing the various embodiments of the present invention, an electronic device may include any device having an embedded web server or web browsing capabilities, such as a personal digital assistant, a cellular phone, a scanner, a digital imaging device, or other device that may require configuration or troubleshooting. Although various electronic devices may be incorporated with the present invention, the various embodiments of the present invention shall be explained with reference to a printing device 200. A printing device 200 may include a printer, a copier, a facsimile machine, a multifunction device, or other device capable of creating hardcopy of media or data. Printing device 200 may also include one or more central processing units for performing the various functions associated with the printing device 200, one or more memories for storing data and programs and one or more displays 210 for displaying information to a user. A display 210 may include a standard display, a touch-screen display, or other display device commonly associated with printing devices 200 or capable of displaying data from a printing device 200. An e-service 220 may also reside in a memory of printing device 200 or on a storage device for access by the printing device 200. The e-service 220 may comprise a computer program or set of programs for retrieving and displaying data received from a database 150, and for executing any fixes associated with selected data. The e-service 220 may comprise a set of programming for carrying out the various embodiments of the present invention. The e-service 220 may also communicate with a web site 110 to retrieve data from databases 150 through an embedded web server 230 or other communication device associated with printing device 200.

An instant fix button 240 may be associated with the e-service 220 operating on printing device 200. The instant fix button 240 may comprise a dedicated button for operating the e-service 220, a printing device 200 button that may be captured by the e-service 220 for carrying out the various embodiments of the present invention, or a virtual button created on display 210, such as with a touch-screen display 210, for executing the various embodiments of the present invention.

The present invention may be used to correct an error or common problem occurring with printing device 200. Using the present invention, a user may operate the printing device 200 to request a list of frequently occurring problems from a database 150 associated with the printing device 200. Typically, the database 150 may be maintained by a customer care center. The customer care center may log frequently encountered problems received by the customer care center representatives into a database 150. In addition, programming or other instructions for fixing the recorded problems may also be recorded in the database 150. A user having a problem with a printing device 200 may operate an e-service 220 of a printing device 200 to access a database 150 to determine if the database 150 includes a quick fix for the problem, thereby allowing the user to fix the problem without the aid of a customer care center representative. Using the e-service 220, the user may request a list of frequently encountered problems from a database 150 associated with the printing device 200. The e-service 220 may use an embedded web server 230 or web client to connect to a web site 110 associated with the printing device 200. Once connected to the web site 110, the web site may query a database 150 for a list of frequently encountered problems associated with the requesting printing device 200. A list of frequently encountered problems may be transmitted to the e-service 220 for display on display 210 of printing device 200. A user may scroll through the list of frequently encountered problems. If the problem that they are trying to correct is found, the user may select that problem to request a fix from the web site 110. A fix associated with the selected problem may then be passed from web site 110 to the printing device 200 and executed by the e-service 220, thereby fixing the problem.

The use of an e-service 220 of the present invention to retrieve a fix for electronic device, for example a printing device 200, also allows a user to bypass security problems commonly associated with computing system firewalls. Because the e-service 220 resides on an electronic device within a network or computing system any requests sent by the e-service 220 to an outside web site 110, or information transferred from the web site 110 or database 150 associated with the web site 110 to the e-service 220, is not stopped by a firewall. Thus, communications and fixes may be performed without additional security measures for bypassing firewalls.

In another embodiment of the present invention, the e-service 220 may be equipped to retrieve search criteria from a user for narrowing the number of problems and associated fixes retrieved from a database 150. A user may provide the e-service 220 with the search criteria using an input device (not shown) associated with the printing device 200 or other electronic device. The search criteria may be used to narrow a search of a database 150 and retrieve only those problems and associated fixes that relate to the search parameters provided by the user.

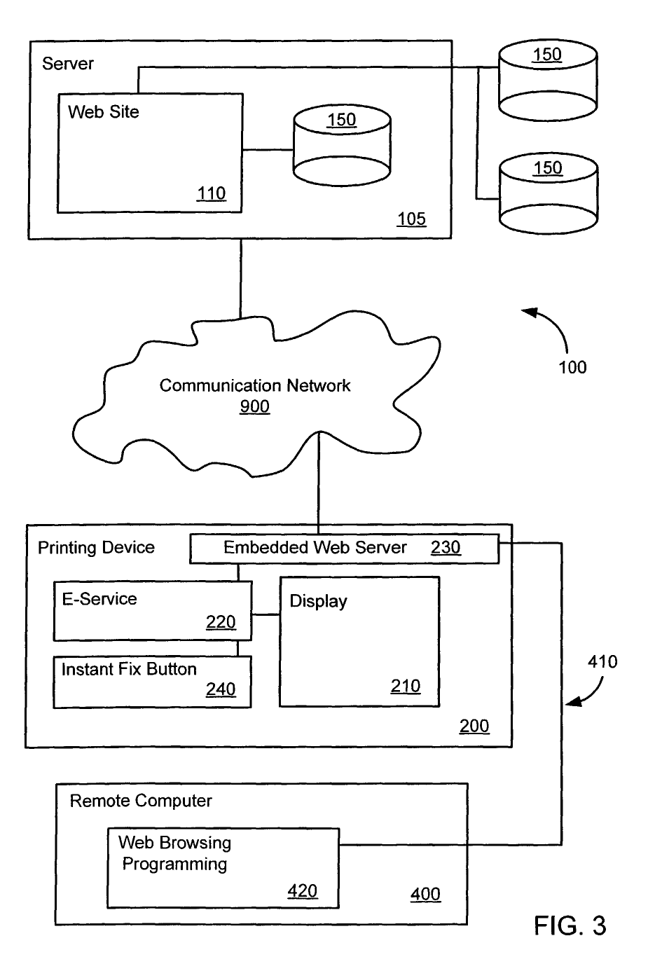

In yet another embodiment of the present invention, a user may remotely access an e-service 220 from an electronic device having embedded web capabilities as illustrated in FIG. 3. For instance, a remote computer 400 may include a communication link 410 with-printing device 200. The communication link 410 between remote computer 400 and printing device 200 may be a wireless or hardwired communication link 410, including a communication link 410 through communication network 900. The remote computer 400 may include programming 420 for communicating with printing device 200 through embedded web server 230. Using the programming 420, data and information associated with the e-service 220 may be displayed on a display device associated with the remote computer 400. A user may therefore operate the e-service 220 from the remote computer 400 for requesting and displaying problems and associated fixes from a database 150. Thus, a remote computer 400 may be used in place of display 210 to view and manipulate the data associated with e-service 220.

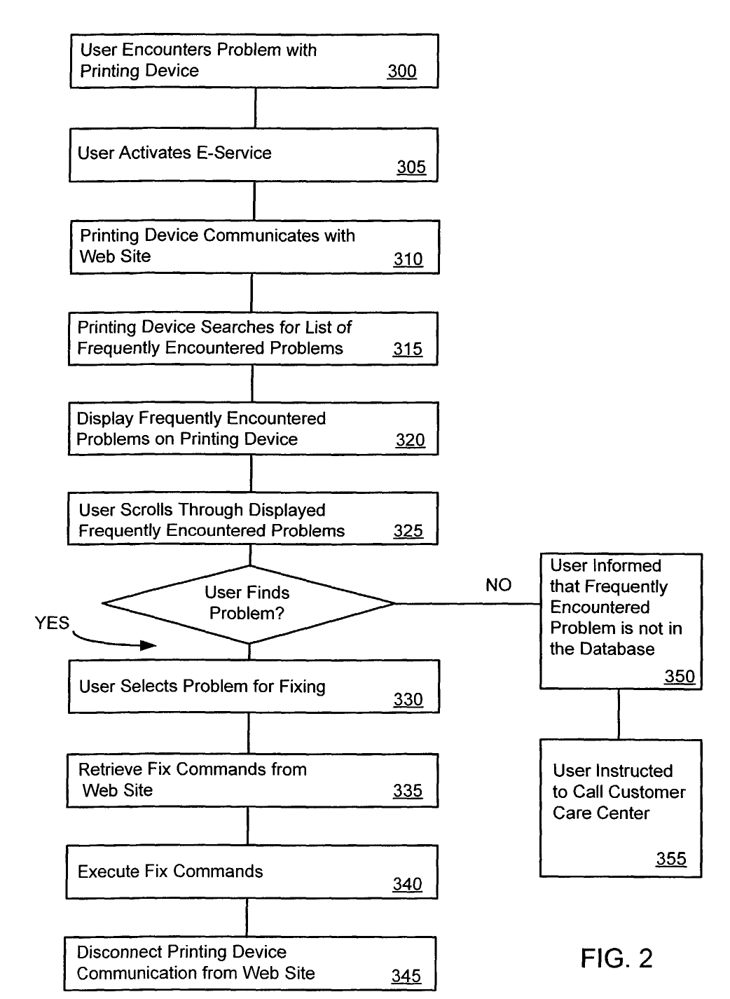

The various embodiments of the present invention may be better understood with reference to FIG. 2, which illustrates a block diagram of the logic involved with the various process steps of the present invention.

Typically, there is no need for the present invention unless a user of a printing device 200 encounters a problem 300 with the printing device 200 that they are unable to solve. Once a problem is encountered 300, a user may activate 305 the e-service 220 residing on the printing device 200. Alternatively, the e-service may be activated according to a preset schedule to automatically search for and correct errors or problems associated with an electronic device or printing device 200 utilizing an e-mail service 220. Upon activation 305, the e-service 220 communicates 310 with an instant fix web site 110 for receiving a set of available problems and associated fix codes. Using the e-service 220, the printing device 200 may search 315 the web site 110 for a database 150 containing a list of frequently encountered problems associated with the particular type, make, or model of printing device 200. A list of frequently encountered problems associated with the printing device 200 may be displayed 320 by the printing device 200 from data received from a database 150. Using control buttons or other control mechanisms associated with the printing device 200, a user may scroll 325 through a list of frequently encountered problems displayed 320 on display 210. If the user finds the particular problem that they have encountered in the scrolling list of frequently encountered problems the user may select 330 an instant fix button 240 for retrieving a fix for the selected problem and implementing the fix on printing device 200. Once selected 330, the instant fix button 240 triggers the e-service 220 to retrieve 335 the fix commands from the database 150 associated with the selected problem. Once received, the e-service 220 executes 340 the fix commands with the printing device 200 to fix the problem for the user. Once the fix commands have been executed 340 the printing device 200 may cease communications 345 with the web site 110.

Upon encountering a problem 300 with a printing device 200 that a user is unable to resolve without help, the e-service 220 may be activated by the user using commands or buttons associated with the printing device 200. Printing devices 200 capable of communicating over communication networks 900, such as with embedded web servers 230, may have an e-service 220 installed in a memory or on a storage device associated with the printing device 200 for carrying out the various embodiments of the present invention.

Communications 310 between an e-service 220 and a web site 110 may occur over a communications network 900 such as an intranet, a network system, or the Internet. The communications 310 may occur using known communication methods and known communication equipment, such as web server 230 associated with printing device 200.

The search 315 for a list of frequently encountered problems may be performed by an e-service 220 or by the coding associated with the web site 110. For instance, an e-service 220 communicating 310 with a web site 110 may inform the web site 110 of the type or model of printing device 200 upon which the e-service 220 resides. Using the type and model information, the web site 110 may direct the e-service 220 to an appropriate database 150 associated with the type and model of the printing device 200. Alternatively, the web site 110 coding may retrieve data from a database 15 0 for the particular printing device and communicate that data to the e-service 220 for manipulation by the e-service 220. In addition, the search 315 performed by the e-service 220 may be limited by user defined parameters retrieved from a user by the e-service 220.

The display 320 of a list of frequently encountered problems associated with a printing device 200 may be controlled by the web site 110 or, preferably, by the printing device 200. The e-service 220 residing on the printing device 200 may be configured to operate in accordance with the limitations of the particular display 210 associated with the printing device 200. Thus, the data stored in a database 150 need not be configured in a particular manner for display 320. Instead, the e-service 220 of the printing device 200 may receive the data and manipulate the data for display 320 in accordance with the limitations of display 210.

A user may scroll 325 through a list of displayed data, or frequently encountered problems, using the printing device 200 controls. When the user finds the problem that they are attempting to fix, the user may select the problem 330 using an instant fix button 240 or other control for selecting the problem. The e-service 220 may record the selected problem and initiate further communications with the web site 110 for retrieving a set of fix instructions to fix the selected problem.

To retrieve 335 fix commands from a web site 110, the e-service 220 may send a query command to the web site 110 requesting the fix commands associated with a problem from a list of frequently encountered problems retrieved from a database 150. The web site 110, upon identifying the selected problem, may query the database 150 for the fix commands associated with the selected problem. The fix commands may then be sent to the e-service 220 of the printing device 200. Typically, the fix commands may be retrieved from the database 150 and sent to the printing device 200 in a stream text data format. For example, the fix commands may be in an XML (Extensible Markup Language) format that may be easily executed by the e-service 220 of the printing device 200.

Fix commands retrieved 335 from the web site 110 may be executed 340 by the e-service 220, resulting in a change to the devices configuration of the printing device 200. The executed 340 commands fix the problem that the user was attempting to fix.

For example, a user operating a printing device 200 with a default paper size setting for A4 paper may wish to change the default setting to standard letter sized paper (8 ½ inch by 11 inch) paper. Not knowing how to execute such change, the user may activate 305 an e-service 220 program resident in a memory of the printing device 200. Upon execution, the c-service 220 establishes a communication link with a web site 110 for providing lists of frequently encountered problems and associated fixes to those problems. The e-service 220 may communicate the particulars about the printing device 200 type and model to the web site 110. Programming codes associated with the web site 110 retrieve a data listing of frequently encountered problems associated with the type and model of the printing device 200 requesting the fix. The data retrieved from database 150 by web site 110 is communicated to the e-service 220. The e-service 220 manipulates the data into a displayable form for the particular printing device 200 and displays 320 the list of frequently encountered problems on the display 210 of the printing device 200. The user may scroll through the list of frequently encountered problems using controls associated with the printing device 200 until the problem they are having is displayed. One such problem may include the changing of default paper size for a printing device 200. Upon finding the user's problem, the user may select the problem using an instant fix button 240. The e-service 220 identifies the selected problem and queries the web site 110 for a solution to the problem. Web site 110 queries the solution to the selected problem from a database 150 and passes fix commands back to the e-service 220. The fix commands may be executed 340 by the e-service 220, thereby solving the problem selected by the user and changing the default paper size of the printing device 200.

In certain instances a problem with a printing device 200 encountered by a user may not be listed in a list of frequently encountered problems. This may occur in those instances where the problem has never before been reported to a customer care center or in those cases where a fix has not yet been created to solve the problem. If a user is unable to find the particular problem that they are having in a list of frequently encountered problems displayed 320 on display 210, the user may be informed 350 that their particular problem has not been encountered before. The e-service 220 may then instruct 355 the user to call a customer care center associated with the printing device 200 to report the problem so that the customer care center may attempt to provide a solution to the problem. A special phone number for reporting unlisted problems may be retrieved from the web site 110 and displayed by the e-service 220 to the user. Alternatively, a user may be prompted to submit an unsolved problem to the customer care center using an online form displayed by the web site 110 on display device 210. The e-service 220 may accept a users input into the online form and submit the information to web site 110 through communication network 900.

A database 150 of frequently encountered problems and fixes to those problems may be built or expanded based upon calls from users who have already attempted to solve their problems using the e-service 220 and instant fix web site 110 of the present invention. A customer care center representative receiving a call about a problem may log the problem in a database 150 and attempt to create a set of codes for providing a solution to the problem that may also be stored in the database 150. In this manner, a database 150 of frequently encountered problems and solutions to those problems may be updated with all of the problems encountered by users.

The various embodiments of the present invention provide systems and methods for allowing a user to actively retrieve a fix to a frequently encountered problem associated with an electronic device, such as a printing device 200. The use of an e-service 220 and web site 110 to retrieve lists of common problems and associated fixes from databases 150 bypasses communications with a customer care center representative. By bypassing individual communications, fixes to common problems may be handled and solved quickly and cheaply. In addition, the e-service 220 executes the fix, preventing human error which commonly occurs and often times results in further problems with a printing device 200.

Although the various embodiments of the present invention have been described with reference to a printing device 200, it is understood that the various embodiments of the present invention may also be used with other electronic devices to provide easy, cheap, reliable and consistent solutions to problems associated with electronic devices.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method for providing a fix to a problem associated with an electronic device, comprising:
selecting a problem with said electronic device for fixing;
retrieving a set of fix codes from a remote database for fixing said selected problem; and
executing said set of fix codes on said electronic device

2. The method of claim 1, wherein said electronic device comprises a printing device.

3. The method of claim 2, wherein said printing device is selected from the group consisting of a printer, a copier, a facsimile machine, and a multifunction device.

4. The method of claim 1, wherein said selecting a problem with said electronic device for fixing comprises:
activating an e-service accessible to said electronic device;
using said e-service to retrieve a list of frequently encountered problems associated with said electronic device;
displaying said retrieved list of frequently encountered problems on a display device of said electronic device; and
selecting at least one of said displayed frequently encountered problems for fixing.

5. The method of claim 4, wherein said using said e-service to retrieve a list of frequently encountered problems associated with said electronic device comprises:
accessing a database for storing frequently encountered problems associated with said electronic device; and
compiling a list of frequently encountered problems associated with said electronic device from said database.

6. The method of claim 4, wherein said using said e-service to retrieve a list of frequently encountered problems associated with said electronic device comprises:
establishing communications between said e-service and a web site; and
retrieving a list of frequently encountered problems associated with said electronic device from said web site.

7. The method of claim 1, wherein said retrieving a set of fix codes from a remote database for fixing said selected problem comprises:
using said e-service to establish a connection to said remote database;
querying said remote database for a set of fix codes associated with said selected problem with said electronic device for fixing; and
retrieving said set of fix codes from said remote database.

8. The method of claim 1, wherein said retrieving a set of fix codes from a remote database for fixing said selected problem comprises:
establishing a connection between said e-service and a web site;
communicating said selected problem to said web site;
using said web site to query said remote database for said set of fix codes for fixing said selected problem; and
communicating said set of fix codes for fixing said selected problem to said e-service.

9. A method for providing a fix to a problem associated with an electronic device, comprising:
initiating an e-service operating on an electronic device;
establishing communications between said e-service and a web site;
using said web site to retrieve a list of data comprising at least one frequently encountered problem associated with said electronic device;
communicating said list of data to said e-service;
displaying said list of data on a display device of said electronic device;
selecting at least one frequently encountered problem from said displayed list for fixing on said electronic device;
communicating said selected at least one frequently encountered problem from said list to said web site;
retrieving a set of fix commands for said selected at least one frequently encountered problem;
communicating said set of fix commands to said e-service; and
executing said set of fix commands for fixing said selected at least one frequently encountered problem.

10. The method of claim 9, wherein said establishing communications between said e-service and a web site comprises:
initiating a web server associated with said electronic device;
requesting a communication with said web site over a communication network; and
establishing a communication link between said web server and said web site using said communication network.

11. The method of claim 9, wherein said using said web site to retrieve a list of data comprising at least one frequently encountered problem associated with said electronic device comprises querying a database for frequently encountered problems associated with said electronic device.

12. The method of claim 9, wherein said displaying said list of data on a display device of said electronic device comprises:
manipulating said list of data communicated to said e-service into a displayable format for said electronic device; and
displaying said list of data in a displayable format on said display device of said electronic device.

13. The method of claim 12, wherein said display device of said electronic device comprises a display device selected from the group consisting of a standard display and a touch-screen display.

14. The method of claim 9, wherein said selecting at least one frequently encountered problem from said displayed list for fixing on said electronic device comprises:
scrolling through said displayed list of frequently encountered problems; and
selecting an instant fix button associated with said electronic device when a desired frequently encountered problem is selected.

15. The method of claim 9, wherein said communicating said set of fix commands to said e-service comprises communicating said set of fix commands to said e-service in a stream text data format.

16. The method of claim 15, wherein said communicating said set of fix commands to said e-service in a stream text data format comprises communicating said set of fix commands to said e-service in an XML format.

17. The method of claim 9, wherein said electronic device comprises a printing device.

18. The method of claim 17, wherein said printing device is selected from the group consisting of a printer, a copier, a facsimile machine, and a multifunction device.

19. A system for fixing problems associated with an electronic device, comprising:
an electronic device;
an e-service operating on said electronic device for fixing problems associated with said electronic device;
a database for providing fixes to problems associated with said electronic device; and
a communication network for providing communications between said e-service and said database.

20. The system of claim 19, further comprising a web site for communicating with said e-service and said database.

21. The system of claim 19, wherein said database comprises a database for storing frequently encountered problems associated with said electronic device and storing fixes to said frequently encountered problems.

22. The system of claim 21, wherein said fixes to said frequently encountered problems stored in said database are stored in a XML format.

23. The system of claim 19, wherein said electronic device comprises a printing device selected from the group consisting of a printer, a copier, a facsimile machine, and a multifunction device.

24. A program for fixing problems associated with electronic devices, comprising:
a first executable portion for retrieving at least one problem from a database;
a second executable portion for identifying a selected problem from the at least one problem retrieved; and
a third executable portion for retrieving and executing a program fix for the selected problem.

25. The program of claim 24, wherein said first executable portion is configured to query a database for problems associated with an electronic device operating said program.

26. The program of claim 25, wherein said first executable portion is further configured to display a list of retrieved problems on a display device associated with the electronic device operating the program.

27. The program of claim 24, wherein said third executable portion is configured to retrieve an executable fix program code from a database and execute said executable fix program code on an electronic device operating said program.
